(19) United States
(12) Patent Application Publication
(10) Pub. No.: US 2015/0377444 A1
(43) Pub. Date: Dec. 31, 2015

(54) Headlight Switching Device for Car

(71) Applicant: Chin-Shu Yin, Tainan City (TW)

(72) Inventors: Chin-Shu Yin, Tainan City (TW); Wei-Fang Chen, Tainan City (TW)

(21) Appl. No.: 14/315,379

(22) Filed: Jun. 26, 2014

(51) Int. Cl. F21S 8/10

(52) U.S. Cl. CPC F21S 48/1747; F21S 48/1705; F21S 48/212; F21W 2101/12

(57) ABSTRACT

A headlight switching device includes a headlight unit and an auxiliary light unit. The headlight unit includes a housing, a low beam, and a high beam. The auxiliary light unit includes two oblique side lights each connected to the turn signal switch of a transportation vehicle. Each of the oblique side lights is arranged in an inclined manner so that the oblique side lights emit light beams in two oblique directions. Thus, the driver starts the turn signal switch when turning the transportation vehicle, to turn off the headlight unit and turn on the auxiliary light unit simultaneously, so that the auxiliary light unit emit light beams to illuminate the zone to be turned, so as to facilitate the driver clearly seeing the road, and to caution a following driver behind the transportation vehicle.

### BACKGROUND OF THE INVENTION

1. Field of the Invention

The present invention relates to a headlight switching device and, more particularly, to a headlight switching device for a wheeled vehicle, such as a car and the like.

2. Description of the Related Art

A conventional turning lighting mechanism for a car comprises a motor having an end provided with a reducer which has an end provided with a shaft, a beveled drive gear connected with the shaft of the reducer, a rotary disk having a bottom provided with a beveled driven gear meshing with the beveled drive gear, a gear box for mounting the beveled drive gear, the rotary disk and the beveled driven gear, two optical detectors mounted on the front portion and side face of the gear box, a microswitch mounted on a side of the beveled drive gear and having a first end provided with a contact lever and a second end provided with a switch, an angle limit bar located at a side of the beveled drive gear to limit the rotation angle of the rotary disk, and a lamp mounted above the rotary disk. The two optical detectors can turn on the lamp automatically when the lightness of the car is changed. Thus, when the driver turn the car, the conventional turning lighting mechanism automatically provides an illumination in the turning direction of the car. However, the lamp cannot be turned previously toward the zone to be turned before the car is turned or steered, so that the driver cannot clearly see the road situation of the zone to be turned, thereby easily causing danger to the driver. In addition, the conventional turning lighting mechanism has a complicated structure, thereby increasing the cost of fabrication.

### BRIEF SUMMARY OF THE INVENTION

The primary objective of the present invention is to provide a headlight switching device with a changeable lighting field.

In accordance with the present invention, there is provided a headlight switching device comprising a headlight unit and an auxiliary light unit connected with the headlight unit. The headlight unit includes a housing, a low beam mounted in the housing, and a high beam mounted in the housing. The low beam of the headlight unit is connected to a turn signal switch of a transportation vehicle. The high beam of the headlight unit is connected to the turn signal switch of the transportation vehicle. The auxiliary light unit includes two oblique side lights mounted in the housing of the headlight unit. The oblique side lights of the auxiliary light unit are located at two opposite sides of the housing. Each of the oblique side lights of the auxiliary light unit is arranged in an inclined manner and is directed outward relative to the housing of the headlight unit, with the oblique side lights of the auxiliary light unit emitting light beams in two oblique directions. Each of the oblique side lights of the auxiliary light unit is connected to the turn signal switch of the transportation vehicle.

In practice, when the turn signal switch of the transportation vehicle is started, the headlight unit is turned off, and the auxiliary light unit is turned on simultaneously, so that the oblique side lights of the auxiliary light unit emit light beams to illuminate a zone to be turned, so as to facilitate the driver clearly seeing the road condition, and to warn a following driver behind the transportation vehicle.

According to the primary advantage of the present invention, the driver starts the turn signal switch when turning the transportation vehicle, to turn off the headlight unit, and to turn on the auxiliary light unit simultaneously, so that the auxiliary light unit emit light beams to illuminate the zone to be turned, so as to facilitate the driver clearly seeing the road, and to caution a following driver behind the transportation vehicle.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a plane view of a headlight switching device in accordance with the preferred embodiment of the present invention.

FIG. 2 is a cross-sectional view of the headlight switching device in accordance with the preferred embodiment of the present invention.

FIG. 3 is a schematic view of the headlight switching device for a transportation vehicle in accordance with the preferred embodiment of the present invention.

FIG. 4 is a schematic operational view of the headlight switching device as shown in FIG. 1 in use.

FIG. 5 is a schematic operational view of the headlight switching device as shown in FIG. 3 in use.

FIG. 6 is a schematic operational view of the headlight switching device as shown in FIG. 1 in use.

FIG. 7 is a schematic operational view of the headlight switching device as shown in FIG. 3 in use.

FIG. 8 is a plane view of a headlight switching device in accordance with another preferred embodiment of the present invention.

FIG. 9 is a cross-sectional view of the headlight switching device in accordance with another preferred embodiment of the present invention.

FIG. 10 is a schematic operational view of the headlight switching device for a transportation vehicle in accordance with another preferred embodiment of the present invention.

FIG. 11 is a schematic operational view of the headlight switching device as shown in FIG. 9 in use.

FIG. 12 is a schematic operational view of the headlight switching device as shown in FIG. 9 in use.

### DETAILED DESCRIPTION OF THE INVENTION

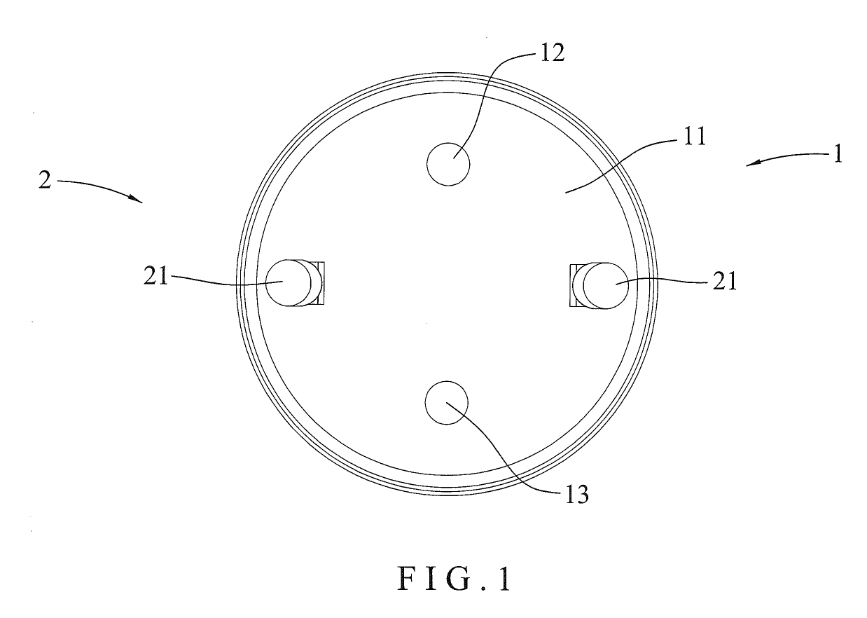

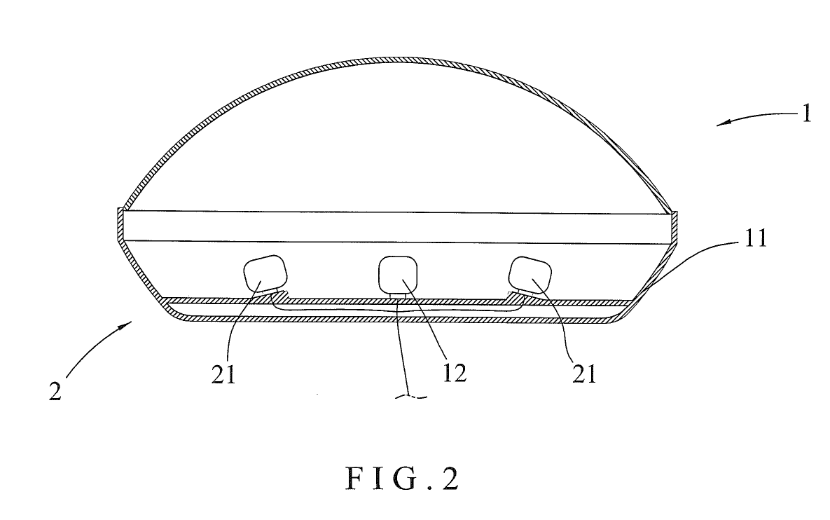

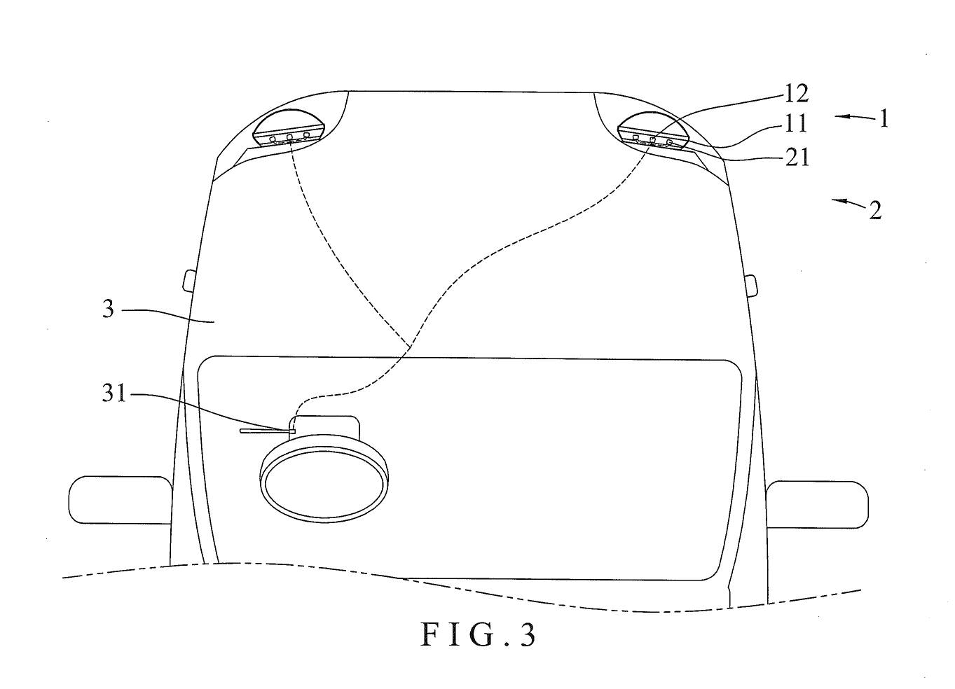

Referring to the drawings and initially to FIGS. 1-7, a headlight switching device in accordance with the preferred embodiment of the present invention comprises a headlight unit 1 and an auxiliary light unit 2 connected with the headlight unit 1.

The headlight unit 1 includes a housing 11, a low beam 12 mounted in the housing 11, and a high beam 13 mounted in the housing 11. The low beam 12 of the headlight unit 1 is connected to a turn signal switch 31 of a transportation vehicle 3 (such as a car). The high beam 13 of the headlight unit 1 is connected to the turn signal switch 31 of the transportation vehicle 3.

The auxiliary light unit 2 includes two oblique side lights 21 mounted in the housing 11 of the headlight unit 1. The oblique side lights 21 of the auxiliary light unit 2 are located at two opposite sides of the housing 11, with the low beam 12 and the high beam 13 of the headlight unit 1 being located between the oblique side lights 21 of the auxiliary light unit 2, and with the oblique side lights 21 of the auxiliary light unit 2 being located between the low beam 12 and the high beam 13 of the headlight unit 1. Each of the oblique side lights 21 of the auxiliary light unit 2 is arranged in an inclined manner and is directed outward relative to the housing 11 of the headlight unit 1, so that the oblique side lights 21 of the auxiliary light unit 2 emit light beams in two oblique directions. Preferably, each of the oblique side lights 21 of the auxiliary light unit 2 is arranged at an inclined angle ranged between twenty and forty-five degrees (20-45°). Each of the oblique side lights 21 of the auxiliary light unit 2 is connected to the turn signal switch 31 of the transportation vehicle 3.

In practice, when the turn signal switch 31 of the transportation vehicle 3 is started, the headlight unit 1 is turned off, and the auxiliary light unit 2 is turned on simultaneously, so that the oblique side lights 21 of the auxiliary light unit 2 emit light beams to illuminate a zone to be turned, so as to facilitate the driver clearly seeing the road condition, and to warn a following driver behind the transportation vehicle 3.

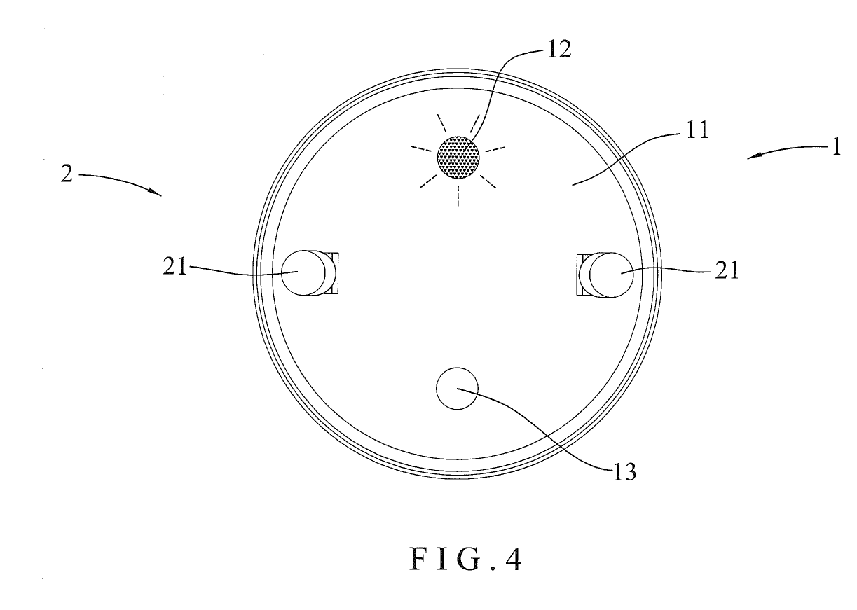

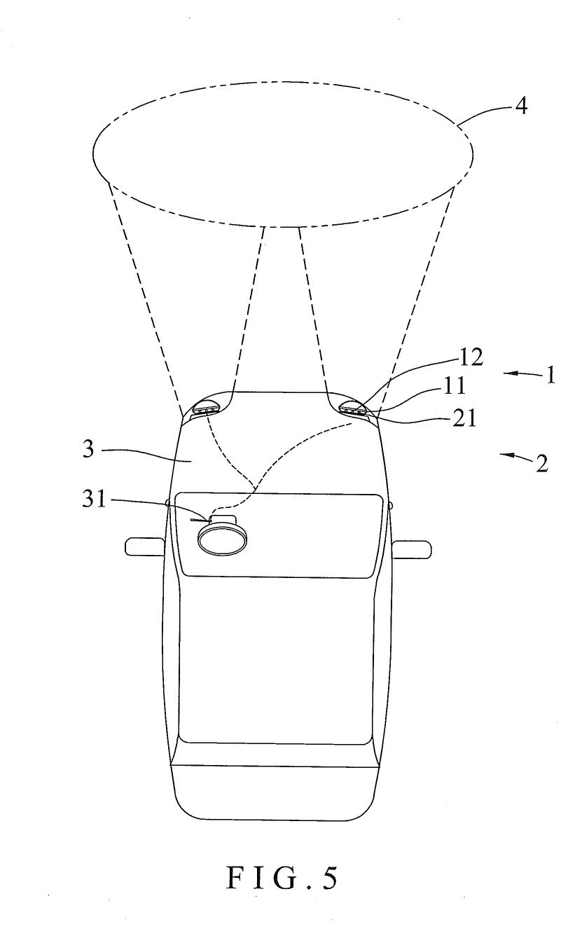

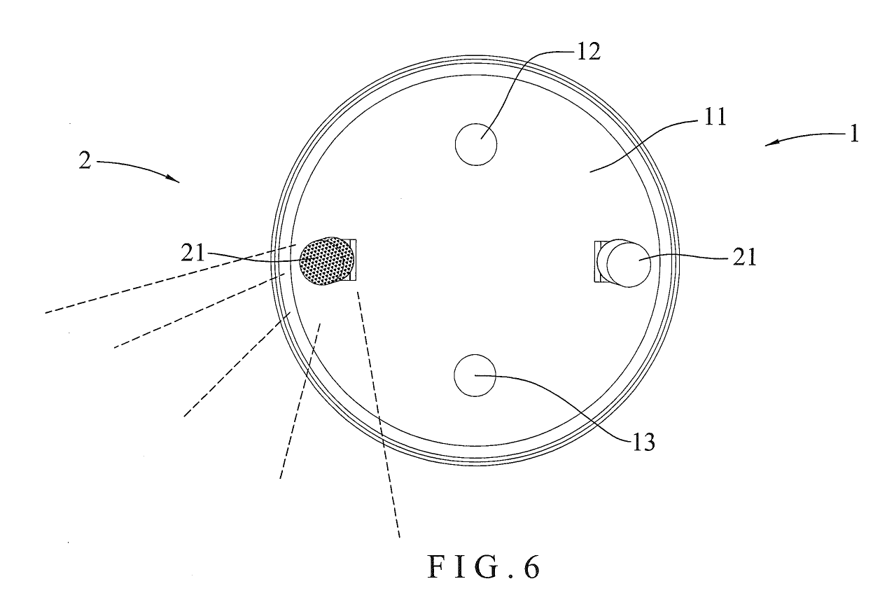

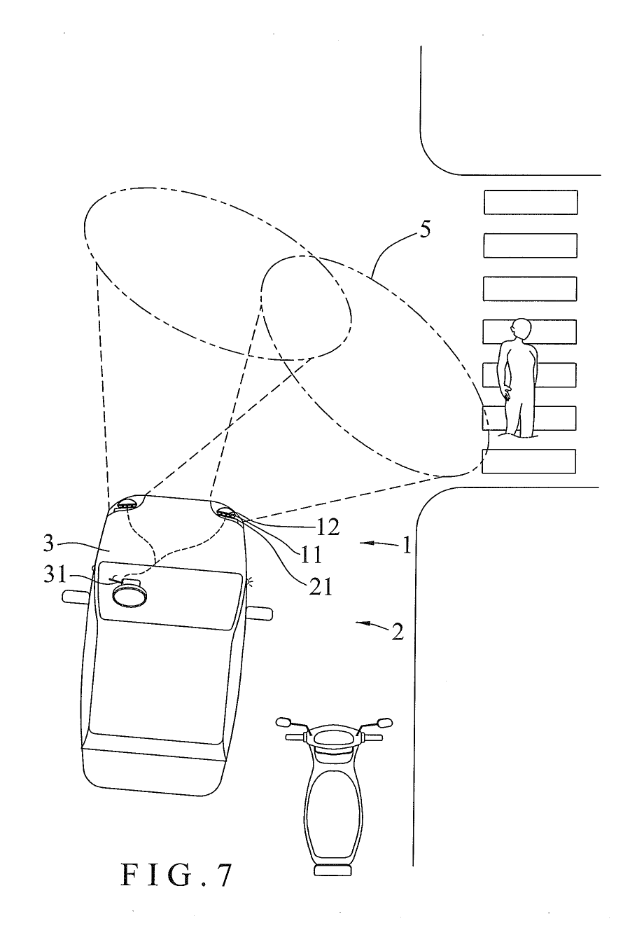

In operation, referring to FIGS. 4-7 with reference to FIGS. 1-3, when the transportation vehicle 3 is driven in the mountain, in a dense fog or at night, the low beam 12 of the headlight unit 1 is turned on as shown in FIG. 4 to emit light beams toward a front zone 4 so as to illuminate the front zone 4 as shown in FIG. 5. When the driver wishes to turn right the transportation vehicle 3, the turn signal switch 31 is started to turn on and blink a right-side turn signal of the transportation vehicle 3. At the same time, the low beam 12 of the headlight unit 1 is turned off, and one of the oblique side lights 21 of the auxiliary light unit 2 is turned on simultaneously as shown in FIG. 6, to emit light beams toward a right-side oblique front zone 5 so as to illuminate the right-side oblique front zone 5 as shown in FIG. 7. In such a manner, the auxiliary light unit 2 provides an illumination in the oblique direction when the transportation vehicle 3 is turned, to facilitate the driver clearly seeing sideward road condition, thereby enhancing the driver's safety when turning the transportation vehicle 3, and thereby cautioning a following driver behind the transportation vehicle 3. On the contrary, when the turn signal switch 31 is closed, the right-side turn signal of the transportation vehicle 3 is turned off. At the same time, one of the oblique side lights 21 of the auxiliary light unit 2 is turned off, and the low beam 12 of the headlight unit 1 is again turned on simultaneously.

Accordingly, the driver starts the turn signal switch 31 when turning the transportation vehicle 3, to turn off the headlight unit 1, and to turn on the auxiliary light unit 2 simultaneously, so that the auxiliary light unit 2 emit light beams to illuminate the zone to be turned, so as to facilitate the driver clearly seeing the road, and to caution a following driver behind the transportation vehicle 3.

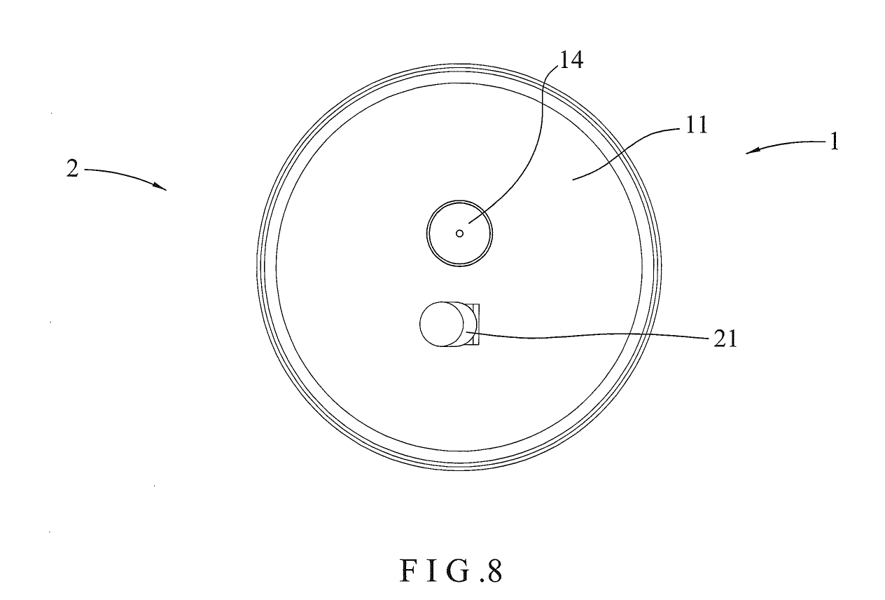

Referring to FIGS. 8-12, a headlight switching device in accordance with another preferred embodiment of the present invention comprises a headlight unit 1 and an auxiliary light unit 2 connected with the headlight unit 1.

The headlight unit 1 includes a housing 11, and a main light 14 mounted in the housing 11. The main light 14 of the headlight unit 1 is a combination of the low beam 12 and the high beam 13 as shown in FIG. 1. The main light 14 of the headlight unit 1 is connected to a turn signal switch 31 of a transportation vehicle 3 (such as a car).

The auxiliary light unit 2 includes an oblique side light 21 mounted in the housing 11 of the headlight unit 1. The oblique side light 21 of the auxiliary light unit 2 is located under the main light 14 of the headlight unit 1. The oblique side light 21 of the auxiliary light unit 2 is arranged in an inclined manner and is directed outward relative to the housing 11 of the headlight unit 1, so that the oblique side light 21 of the auxiliary light unit 2 emits light beams in an oblique direction. The oblique side light 21 of the auxiliary light unit 2 is connected to the turn signal switch 31 of the transportation vehicle 3. The oblique side light 21 of the auxiliary light unit 2 includes an auxiliary low beam 211 and an auxiliary high beam 212. The auxiliary low beam 211 and the auxiliary high beam 212 of the oblique side light 21 are located at two opposite sides oblique side light 21.

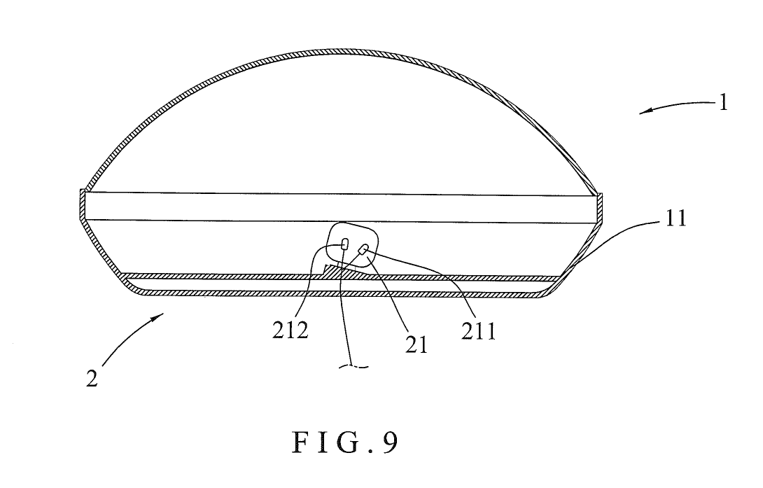

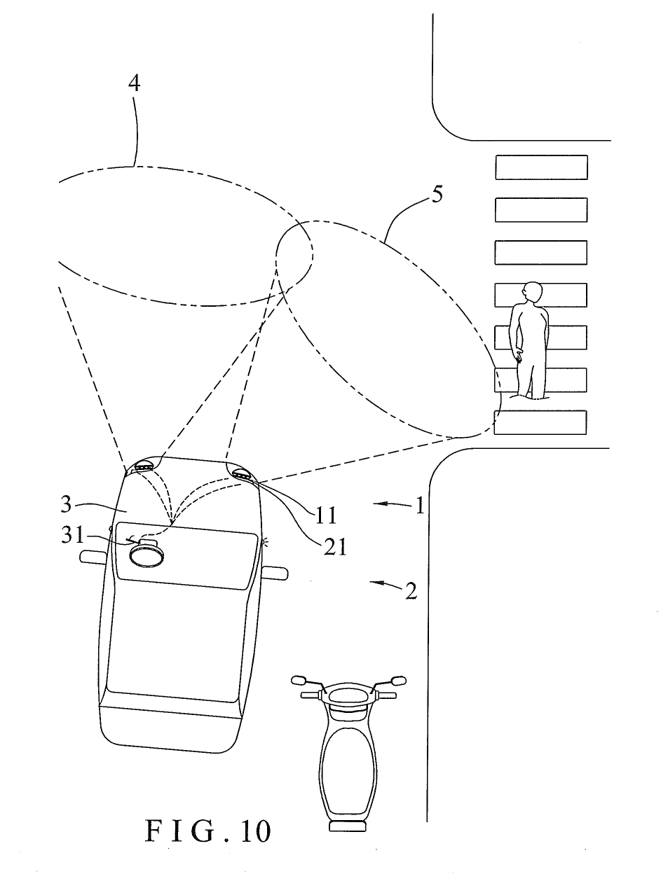

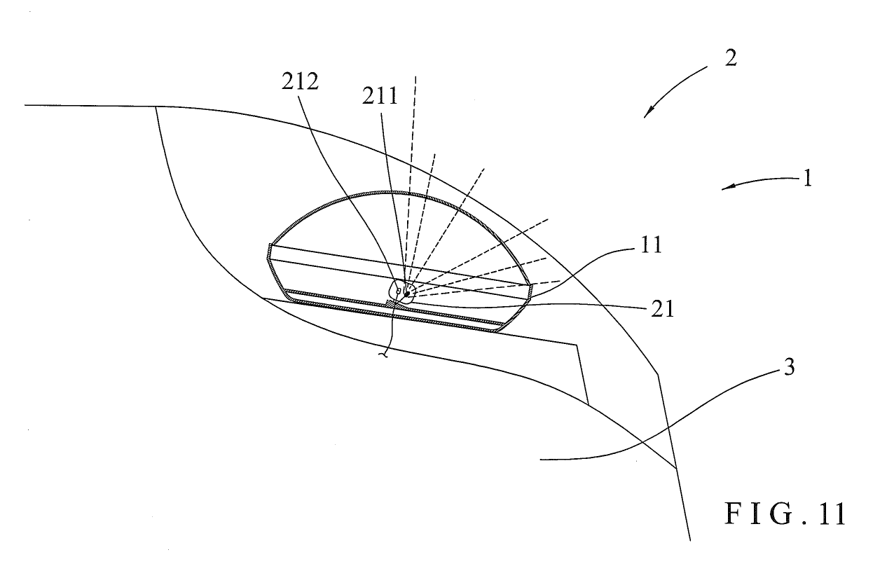

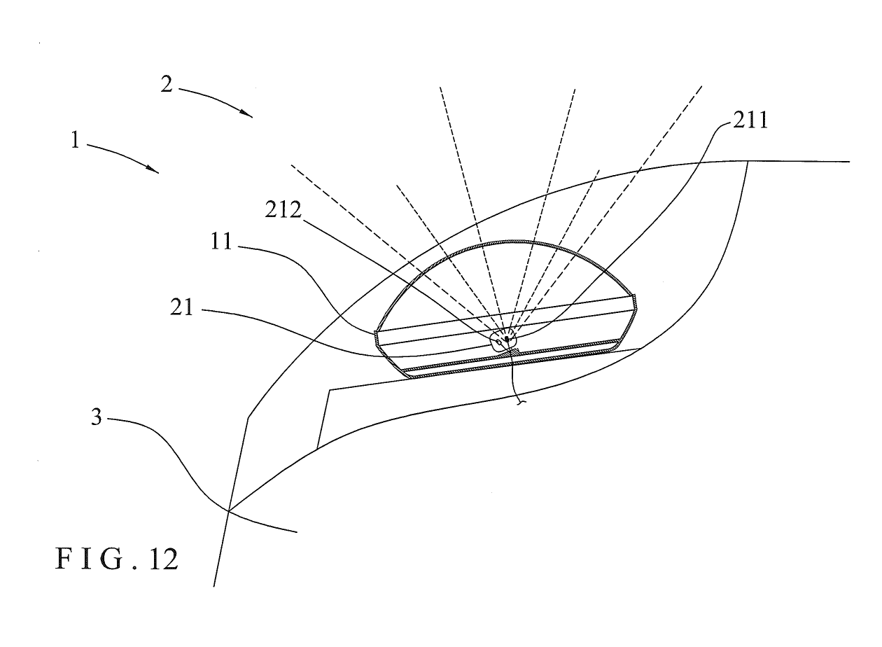

In operation, referring to FIGS. 10-12 with reference to FIGS. 8 and 9, when the driver wishes to turn right the transportation vehicle 3, the turn signal switch 31 is started to turn on and blink a right-side turn signal of the transportation vehicle 3. At the same time, the main light 14 of the headlight unit 1 is turned off, and the auxiliary low beam 211 of the oblique side light 21 at the right side of the transportation vehicle 3 is turned on simultaneously as shown in FIG. 11 to emit light beams toward a right-side oblique front zone 5 so as to illuminate the right-side oblique front zone 5 as shown in FIG. 10. At the same time, the auxiliary low beam 211 of the oblique side light 21 at the left side of the transportation vehicle 3 is turned on simultaneously as shown in FIG. 12 to emit light beams toward a front zone 4 so as to illuminate the front zone 4 as shown in FIG. 10. Thus, the driver can clearly see the road situation of the front zone 4 and the right-side oblique front zone 5.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A headlight switching device comprising:
a headlight unit; and
an auxiliary light unit connected with the headlight unit;
wherein:
the headlight unit includes:
a housing;
a low beam mounted in the housing; and
a high beam mounted in the housing;
the low beam of the headlight unit is connected to a turn signal switch of a transportation vehicle;
the high beam of the headlight unit is connected to the turn signal switch of the transportation vehicle;
the auxiliary light unit includes two oblique side lights mounted in the housing of the headlight unit;
the oblique side lights of the auxiliary light unit are located at two opposite sides of the housing;
each of the oblique side lights of the auxiliary light unit is arranged in an inclined manner and is directed outward relative to the housing of the headlight unit, with the oblique side lights of the auxiliary light unit emitting light beams in two oblique directions;
each of the oblique side lights of the auxiliary light unit is connected to the turn signal switch of the transportation vehicle; and
when the turn signal switch of the transportation vehicle is started, the headlight unit is turned off, and the auxiliary light unit is turned on simultaneously, so that the oblique side lights of the auxiliary light unit emit light beams to illuminate a zone to be turned, so as to facilitate the driver clearly seeing the road condition, and to warn a following driver behind the transportation vehicle.

2. The headlight switching device of claim 1, wherein each of the oblique side lights of the auxiliary light unit is arranged at an inclined angle ranged between twenty and forty-five degrees (20-45°).

3. A headlight switching device comprising:
a headlight unit; and
an auxiliary light unit connected with the headlight unit;
wherein:
the headlight unit includes:
a housing; and
a main light mounted in the housing;
the main light of the headlight unit is connected to a turn signal switch of a transportation vehicle;
the auxiliary light unit includes an oblique side light mounted in the housing of the headlight unit;
the oblique side light of the auxiliary light unit is located under the main light of the headlight unit;
the oblique side light of the auxiliary light unit is arranged in an inclined manner and is directed outward relative to the housing of the headlight unit, with the oblique side light of the auxiliary light unit emitting light beams in an oblique direction; and
the oblique side light of the auxiliary light unit is connected to the turn signal switch of the transportation vehicle.

4. The headlight switching device of claim 3, wherein the oblique side light of the auxiliary light unit includes an auxiliary low beam, and an auxiliary high beam, and the auxiliary low beam and the auxiliary high beam of the oblique side light are located at two opposite sides oblique side light.
